(19) United States
(12) Patent Application Publication
(10) Pub. No.: US 2023/0035078 A1
(43) Pub. Date: Feb. 2, 2023

(54) METHOD FOR ASSISTING A COUPLING PROCEDURE TO BE PERFORMED AT AN AGRICULTURAL IMPLEMENT INTERFACE

(71) Applicant: DEERE & COMPANY, MOLINE, IL (US)

(72) Inventors: MARTIN HEITLINGER, Oestringen (DE); FLORIAN REINMUTH, Sinsheim (DE); MARC SCHAEFER, MAINZ (DE)

(21) Appl. No.: 17/811,604

(22) Filed: Jul. 11, 2022

(30) Foreign Application Priority Data
Jul. 29, 2021 (DE) 102021119683.3

(51) Int. Cl. A01B 59/00; A01B 59/043; G06T 7/70

(52) U.S. Cl. CPC A01B 59/002; A01B 59/043; G06T 7/70

(57) ABSTRACT

A method for assisting a coupling operation to be carried out at a three-point powerlift of an agricultural tractor includes determining via a control unit in communication with an imaging device using image capture and analysis a spatial actual position of implement-side coupling points of the implement interface relative to the tractor-side coupling points, steering via the control unit the agricultural tractor along a predetermined trajectory into an end position provided for the attachment of the implement, and activating via the control unit the actuator arrangement in accordance with the course of the predetermined trajectory such that the tractor-side coupling points take up a spatial desired position provided for attaching the implement-side coupling points.

### CROSS-REFERENCE TO RELATED APPLICATIONS

This application claims priority to German Patent Application No. 102021119683.3, filed Jul. 29, 2021, which is hereby incorporated by reference.

### FIELD OF THE DISCLOSURE

The disclosure relates to a method for assisting a coupling operation to be carried out at a three-point powerlift of an agricultural tractor.

### BACKGROUND

The routine attaching of agricultural implements to a three-point powerlift requires the operator to have appropriate experience since the tractor-side coupling points located at the free ends of the lower links, generally catch hooks for receiving corresponding coupling balls, generally cannot be seen from a driver's cab of the agricultural tractor. A possible misalignment in relation to the implement-side coupling points to be attached thereto therefore cannot be readily seen by the operator and may make it necessary for the operator to repeatedly leave the driver's cab in order to manually correct the position of the lower links.

### SUMMARY

In view of this, it is the object of the present disclosure to configure a method of the type mentioned at the beginning in respect of comfortably attaching an implement interface to a three-point powerlift of an agricultural tractor. This object is achieved by a method having the features of one or more of the following embodiments.

In the case of the method according to the disclosure for assisting a coupling operation to be carried out at a three-point powerlift of an agricultural tractor, the three-point powerlift has right and left lower links at which tractor-side coupling points for attaching an implement interface are provided, which coupling points can be adjusted with respect to a spreading extent, a lateral offset and/or a height position by means of an actuator arrangement. In a starting position taken up by the agricultural tractor, a control unit is used to determine, by image capture and analysis by means of an imaging device, a spatial actual position of implement-side coupling points of the implement interface relative to the tractor-side coupling points, wherein the agricultural tractor is brought along a predetermined trajectory into an end position provided for the attachment of the implement, and the actuator arrangement is activated in accordance with the course of the predetermined trajectory in such a manner that the tractor-side coupling points take up a spatial desired position for attaching the implement-side coupling points.

This relieves the operator of the necessity of bringing the lower links manually into a suitable position for attaching the implement interface. However, the operator is still responsible for stipulating the direction of travel and travel speed of the agricultural tractor for traveling along the trajectory.

The tractor-side coupling points provided at the free ends of the lower links are generally formed by catch hooks into which coupling balls included by the implement interface or the implement-side coupling points can be latched.

The spreading extent here describes a horizontal distance between the tractor-side coupling points, whereas the lateral offset represents a joint horizontal deflection of the tractor-side coupling points from a centered or neutral central position. The height position furthermore refers to a vertical distance of the tractor-side coupling points in relation to the earth's surface. In order to be able to undertake an appropriate adjustment of the two lower links, the latter are each articulated pivotably both in a horizontal and in a vertical direction at a tractor-side end by means of associated ball and socket joints. In order to change the spreading extent and the lateral offset, the actuator arrangement comprises individually length-adjustable lateral stabilizers which run between the relevant lower link and a tractor-side supporting point and can be actuated hydraulically or electrically. By contrast, the height position is changed by means of a hydraulic lifting mechanism of conventional design that is likewise part of the actuator arrangement.

The desired position of the tractor-side coupling points, which desired position is transformed by the control unit on the basis of the geometry, which is presumed to be known, of the three-point powerlift used, into corresponding values for spreading extent, lateral offset and height position, is ideally predetermined by the control unit in such a manner that, in the end position of the agricultural tractor that is provided for attaching the implement, the catch hooks come to lie aligned below the coupling balls of the implement interface in such a manner that, for the mounting of the implement interface, the lower links have to be raised by means of the hydraulic lifting mechanism merely until the coupling balls latch securely in the catch hooks. The upper link of the three-point powerlift is subsequently mounted by hand into an upper coupling point of the implement interface. The coupling operation is therefore finished and the implement is ready for operation.

Advantageous developments of the method according to the disclosure are apparent from the following.

In order to determine the spatial actual position, an optical identification of the implement-side coupling points can be carried out in advance by the control unit. This can take place either by the operator, by marking the implement-side coupling points that are visualized via an operating and display unit, or else automatically on the basis of the image capture and analysis carried out by means of a previously trained neural network, for example what is referred to as convolutional neural network. For this purpose, the agricultural tractor is brought into a starting position lying within a permissible tolerance range for carrying out the coupling operation.

If the starting position lies outside the permissible tolerance range, this being recognized by the control unit on account of the actual position of the implement-side coupling points relative to the tractor-side coupling points and on account of the actuation extent, which is presumed to be known, of the lateral stabilizers used or of the hydraulic lifting mechanism taking into account the specific kinematic model of the agricultural tractor, the coupling operation can be stopped and the operator informed about this. Such a situation arises, for example, whenever the agricultural tractor is in an unfavorable pitch angle at an all too small distance from the implement, and therefore it cannot be brought without repeated maneuvering into an end position suitable for attaching the implement.

The imaging device used for the image capture and analysis can be configured in the form of a stereo camera, an RGB camera or a 3D laser scanner, wherein said device optically detects the spatial position of the implement-side coupling points from the agricultural tractor. In the case of a rear powerlift, the imaging device is located in the rear region of the agricultural tractor. The imaging device furthermore permits an optical detection of the implement-side coupling points for the purpose of the visualization on the operating and display unit.

At the same time, monitoring of the surroundings in the region of the three-point powerlift can be carried out by means of the imaging device. Obstacles lying along the trajectory to be traveled along can thus be recognized promptly such that the coupling operation can be stopped if required and the operator informed about this.

With regard to the stipulation of the trajectory, there are various possibilities.

Thus, in the event of an operator-side stipulation, the desired position and therefore the spreading extent, the lateral offset and/or the height position of the tractor-side coupling points can be dynamically adapted by the control unit in accordance with an observed actual course of the trajectory. The actual course of the trajectory arises here from the operator-side stipulations of direction of travel and travel speed and is determined by the control unit on the basis of position information obtained with GPS assistance or else by recording the position of steerable front wheels in conjunction with the travel speed of the agricultural tractor.

If the control unit determines, on the basis of a kinematic model specific to the agricultural tractor, that the agricultural tractor cannot be brought along the observed course of the trajectory into a suitable end position for attaching the implement-side coupling points, a coupling operation is stopped. At the same time, the operator can be informed about the stoppage. This is the case whenever the setting of the required desired position at the tractor-side coupling points is not possible since otherwise the actuation extent of the lateral stabilizers used or of the hydraulic lifting mechanism would be exceeded.

On the other hand, the course of the trajectory can also be predetermined computationally by the control unit on the basis of a kinematic model of the agricultural tractor. In the event of a computational stipulation of the trajectory, the desired position and therefore the spreading extent, the lateral offset and/or the height position of the tractor-side coupling points can be fixedly set by the control unit. The operator can then be guided with

GPS assistance along the trajectory to be traveled along, for which purpose the course of said trajectory, including corresponding steering commands, is depicted cartographically on the operating and display unit. In addition, corresponding spoken instructions can be issued. On the other hand, it is also conceivable for the predetermined trajectory to be traveled along in that the steering is performed autonomously by an associated vehicle controller, whereas the stipulation of the travel speed continues to remain the responsibility of the operator. Such a vehicle controller is known by the name “AutoTrac” in agricultural tractors from John Deere.

The above and other features will become apparent from the following detailed description and accompanying drawings.

### BRIEF DESCRIPTION OF THE DRAWINGS

The method according to the disclosure for assisting a coupling operation to be carried out at a three-point powerlift of an agricultural tractor is described in more detail below with reference to the attached drawings, in which:

FIG. 1 shows a schematically illustrated exemplary embodiment of an arrangement for carrying out the method according to the disclosure;

FIG. 2 shows an illustration of a coupling operation to be carried out at a three-point powerlift of an agricultural tractor; and

FIG. 3 shows an exemplary embodiment, depicted in the form of a flow diagram, of the method according to the disclosure.

### DETAILED DESCRIPTION

The embodiments or implementations disclosed in the above drawings and the following detailed description are not intended to be exhaustive or to limit the present disclosure to these embodiments or implementations.

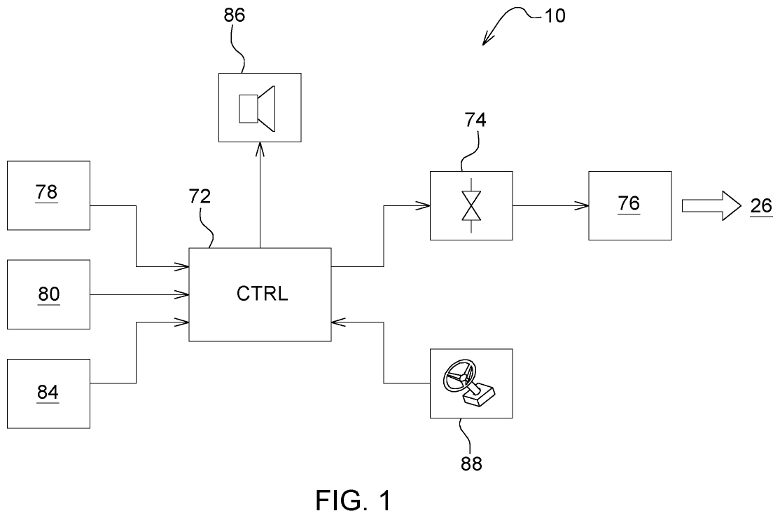

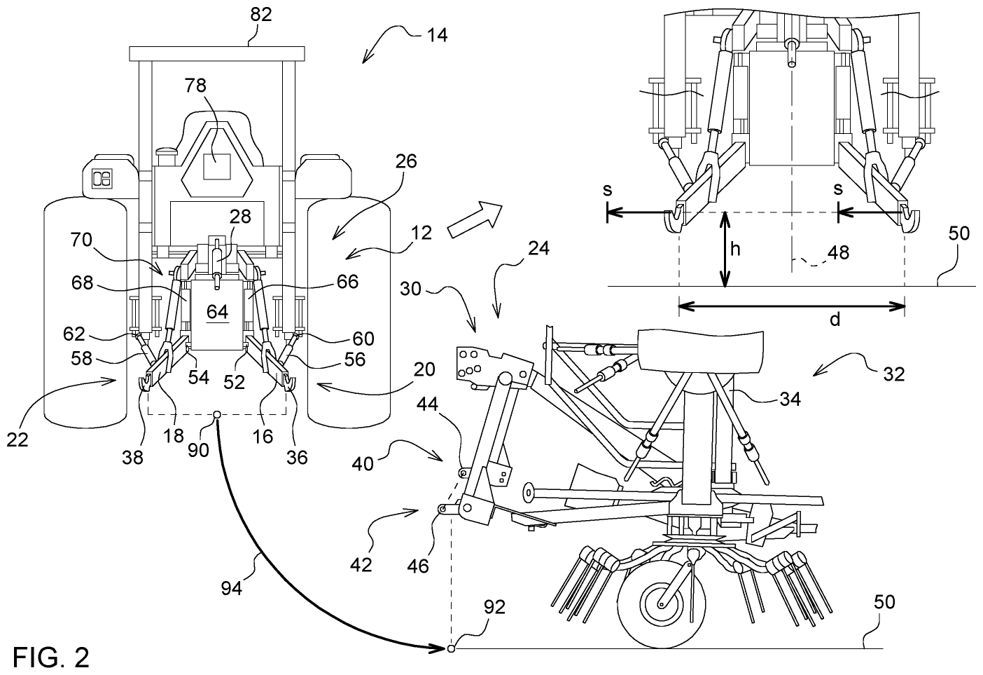

FIG. 1 shows an exemplary embodiment of an arrangement 10 for carrying out the method according to the disclosure for assisting a coupling operation to be carried out at a three-point powerlift 12 of an agricultural tractor 14 according to FIG. 2.

As can be seen in FIG. 2, the three-point powerlift 12 has right and left lower links 16, 18 at which tractor-side coupling points 20, 22 for attaching an implement interface 24 are provided, which coupling points can be adjusted with respect to a spreading extent, a lateral offset and/or a height position by means of an actuator arrangement 26. Furthermore, there is an upper link 28 which can be mounted in an upper coupling point 30 of the implement interface 24. For example, the implement 32 to be attached to the three-point powerlift 12 is configured as a rotary rake 34, but it may alternatively also be a carried or drawn implement of any other design.

The tractor-side coupling points 20, 22 provided at the free ends of the lower links 16, 18 are formed by catch hooks 36, 38 into which coupling balls 44, 46 included by the implement interface 24 or implement-side coupling points 40, 42 can be latched. In this case, the spreading extent describes a horizontal distance d of the catch hooks 36, 38 with respect to each other, whereas the lateral offset depicts a joint horizontal deflection s of the catch hooks 36, 38 from a centered or neutral central position 48 (by way of example, a deflection s to the left is indicated in FIG. 2, but this may equally well also be directed in the opposite direction). The height position furthermore relates to a vertical distance h of the catch hooks 36, 38 in relation to the earth's surface 50. The distances defined to this extent each refer here to a geometrical center point of the relevant tractor-side coupling point 20, 22.

In order to be able to undertake a corresponding adjustment of the two lower links 16, 18, the latter are each articulated pivotably both in the horizontal direction and in the vertical direction by means of associated ball and socket joints 52, 54 at a tractor-side end. In order to change the spreading extent and lateral offset, the actuator arrangement 26 comprises individually length-adjustable lateral stabilizers 56, 58 which run between the relevant lower link 16, 18 and a tractor-side supporting point 60, 62 in the region of a rear axle differential housing 64 and in the present case can be actuated hydraulically. The height position is changed by means of right and left lifting cylinders 66, 68 of a hydraulic lifting mechanism 70 which is likewise part of the actuator arrangement 26.

According to FIG. 1, an electronic control unit 72 serves as part of the arrangement 10, included by the agricultural tractor 14, for activating the actuator arrangement 26, for which purpose said arrangement 10 comprises a plurality of valves 74 which are actuatable electrically by the control unit 72 and interact with a hydraulic system 76 of the agricultural tractor 14 in such a manner that the hydraulic lateral stabilizers 56, 58 and the lifting cylinders 66, 68 assigned to the hydraulic lifting mechanism 70 can be retracted and extended in a controlled manner.

An imaging device 78 which communicates with the control unit 72 and is in the form of a stereo camera, an RGB camera or a 3D laser scanner serves for optically detecting the spatial position of the implement-side coupling points 40, 42 from the agricultural tractor 14. In the case of the rear powerlift illustrated in FIG. 2, the imaging device 78 is situated in the rear region of the agricultural tractor 14.

The implement-side coupling points 40, 42 which are optically detected by means of the imaging device 78 are visualized, inter alia, on an operating and display unit 80 connected to the control unit 72. Said operating and display unit 80 is configured as a touch-sensitive display and is situated in a driver's cab 82 of the agricultural tractor 14.

In addition, the arrangement 10 comprises further components which are connected to the control unit 72. These components include a navigation system 84, a voice output unit 86 and a vehicle controller 88 for autonomously steering the agricultural tractor 14. Such a vehicle controller 88 is known under the name “AutoTrac” in John Deere agricultural tractors.

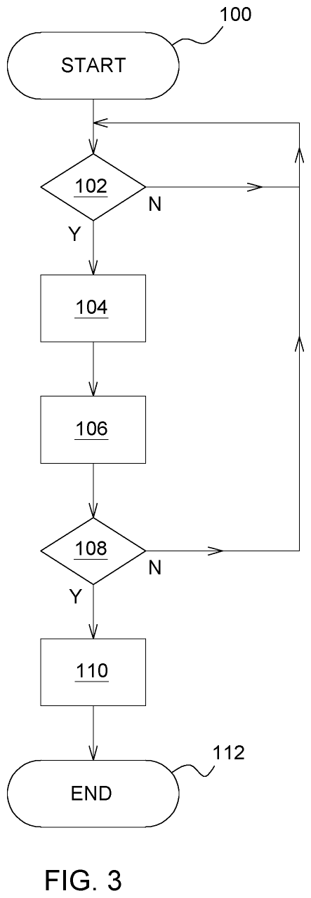

The operation of the arrangement 10 will now be explained with reference to the flow diagram which is shown in FIG. 3 and which depicts an exemplary embodiment of the method according to the disclosure.

When the agricultural tractor 14 is started up, the method carried out by the control unit 72 is initialized in a starting step 100, whereupon it is enquired in a first step 102 whether the carrying out of a coupling operation between agricultural tractor 14 and implement 32 is desired by the operator. If this is the case, which the operator makes known by a corresponding input via the operating and display unit 80, a second step 104 is proceeded with. Otherwise, the method returns to the first step 102.

In the second step 104, first of all a detection of the surroundings by means of the imaging device 78 is carried out by the control unit 72. This has the purpose of identifying the implement interface 24 lying within the detection region or the implement-side coupling points 40, 42 included by said implement interface 24. The identification takes place either by the operator, by marking the implement-side coupling points 40, 42 which are visualized via the operating and display unit 80, or else automatically during the image capture and analysis by means of a previously trained neural network, for example what is referred to as a convolutional neural network. For carrying out the image capture and analysis, use is made of the imaging device 78 which communicates with the control unit 72.

After successful identification of the implement-side coupling points 40, 42, the spatial actual position of said coupling points relative to the tractor-side coupling points 20, 22 is determined in a third step 106. The actual position is determined within the scope of the image capture and analysis carried out by the control unit 72 in the second step 104.

The determined actual position is used by the control unit 72 in a fourth step 108 in order to check whether the agricultural tractor 14 is in a starting position 90 lying within a tolerance range permissible for carrying out the coupling operation.

If the starting position 90 lies outside the permissible tolerance range, which is recognized by the control unit 72 on the basis of the determined actual position of the implement-side coupling points 40, 42 relative to the tractor-side coupling points 20, 22, and on the basis of the actuation extent, which is presumed to be known, of the lateral stabilizers 56, 58 used or of the hydraulic lifting mechanism 70 taking into account the specific kinematic model of the agricultural tractor 14, the coupling operation is stopped, and the method returns to the first step 102. At the same time, the control unit 72 initiates the issuing of corresponding operator information via the operating and display unit 80 situated in the driver's cab 82. Such a situation arises, for example, if the agricultural tractor 14 is at an unfavorable pitch angle at all too small a distance from the implement 32, and therefore said tractor cannot be brought without repeated maneuvering into an end position 92 suitable for attaching the implement 32.

If, by contrast, the control unit 72 recognizes in the fourth step 108 that the starting position 90 taken up by the agricultural tractor 14 lies within the permissible tolerance range, the operator is requested in a fifth step 110 via the operating and display unit 80 to start the coupling operation by driving the agricultural tractor 14 up to the implement 32. For this purpose, the agricultural tractor 14 is brought along a predetermined trajectory 94 into the end position 92 provided for attaching the implement 32, wherein the actuation arrangement 26 is activated by the control unit 72 in accordance with the course of the predetermined trajectory 94 in such a manner that the tractor-side coupling points 20, 22 take up a spatial desired position provided for attaching the implement-side coupling points 40, 42. At the same time, monitoring of the surroundings in the region of the three-point powerlift 12 is carried out by means of the imaging device 78. Obstacles lying along the trajectory 94 to be traveled along are thus recognized promptly such that the coupling operation can be stopped if required and the operator informed about this by corresponding activation of the operating and display unit 80.

The desired position of the tractor-side coupling points 20, 22 which the control unit 72 transforms on the basis of the geometry, which is presumed to be known, of the three-point powerlift 12 used into corresponding values for spreading extent, lateral offset and height position, is predetermined by the control unit 72 in the fifth step 110 in such a manner that, in the end position 92 of the agricultural tractor 14 that is provided for attaching the implement 32, the catch hooks 36, 38 come to lie aligned below the coupling balls 44, 46 of the implement interface 24 in such a manner that, for the mounting of the implement interface 24, the lower links 16, 18 have to be raised by means of the hydraulic lifting mechanism 70 until the coupling balls 44, 46 latch securely into the catch hooks 36, 38. The upper link 28 of the three-point powerlift 12 is subsequently mounted by hand into the upper coupling point 30 of the implement interface 24. The coupling operation is therefore finished and the implement 32 is ready for operation. The method is then ended in an end step 112.

There are various possibilities with regard to the stipulation of the trajectory 94.

Operator-Side Stipulation

In the event of an operator-side stipulation, the desired position and therefore the spreading extent, the lateral offset and/or the height position of the tractor-side coupling points 20, 22 is dynamically adapted by the control unit 72 in accordance with an observed actual course of the trajectory 94. The actual course of the trajectory 94 arises here from the operator-side stipulations of direction of travel and travel speed and is determined by the control unit 72 on the basis of position information obtained with GPS assistance by means of the navigation system 84 or else by recording the position of steerable front wheels in conjunction with the travel speed of the agricultural tractor 14.

If the control unit 72 determines on the basis of a kinematic model specific to the agricultural tractor 14 that the agricultural tractor 14 cannot be brought along the observed course of the trajectory 94 into the end position 92 suitable for attaching the implement-side coupling points 40, 42, the coupling operation is stopped, and the method returns to the first step 102. At the same time, the control unit 72 initiates the outputting of corresponding operator information via the operating and display unit 80 situated in the driver's cab 82. This is the case if the setting of the required desired position at the tractor-side coupling points 20, 22 is not possible since otherwise the actuation extent of the lateral stabilizers 56, 58 used or of the hydraulic lifting unit 70 would be exceeded.

Computational Stipulation

Alternatively, the course of the trajectory 94 is computationally predetermined by the control unit 72 on the basis of a kinematic model of the agricultural tractor 14. In the case of a computational stipulation of the trajectory 94, the desired position and therefore the spreading extent, the lateral offset and/or the height position of the tractor-side coupling points 20, 22 is fixedly set by the control unit 72 at the beginning of carrying out the coupling operation. The operator is subsequently guided with GPS assistance along the trajectory 94 to be traveled along, for which purpose the course of said trajectory, including corresponding steering commands, is depicted cartographically on the operating and display unit 80 at the instigation of the navigation system 84. In addition, corresponding spoken instructions are issued via the speech output unit 86. In a departure therefrom, the predetermined trajectory 94 can also be traveled along in that the steering is performed autonomously on the part of the vehicle controller 88, whereas the stipulation of the travel speed continues to remain the responsibility of the operator.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for assisting a coupling operation to be carried out at a three-point powerlift of an agricultural tractor including right and left lower links having tractor-side coupling points for attaching an implement interface, the tractor-side coupling points adjustable with respect to a spreading extent, a lateral offset, and a height position via an actuator arrangement, comprising:
determining via a control unit in communication with an imaging device using image capture and analysis a spatial actual position of implement-side coupling points of the implement interface relative to the tractor-side coupling points;
steering via the control unit the agricultural tractor along a predetermined trajectory into an end position provided for the attachment of the implement; and
activating via the control unit the actuator arrangement in accordance with the course of the predetermined trajectory such that the tractor-side coupling points take up a spatial desired position provided for attaching the implement-side coupling points.

2. The method of claim 1, wherein, in order to determine the spatial actual position, an optical identification of the implement-side coupling points is carried out in advance by the control unit.

3. The method of claim 1, wherein the imaging device used for the image capture and analysis includes one of a stereo camera, an RGB camera, and a 3D laser scanner.

4. The method of claim 1, further comprising:
monitoring via the imaging device surroundings in the region of the three-point power-lift.

5. The method of claim 1, wherein, in the event of an operator-side stipulation of the predetermined trajectory, the desired position including the spreading extent, the lateral offset, and the height position of the tractor-side coupling points is dynamically adapted by the control unit in accordance with an observed actual course of the trajectory.

6. The method of claim 5, wherein the coupling operation is stopped if the control unit determines based on a kinematic model specific to the agricultural tractor that the agricultural tractor cannot be brought along the observed course of the trajectory into an end position suitable for attaching the implement-side coupling points.

7. The method of claim 1, wherein the predetermined trajectory is predetermined computationally by the control unit based on a kinematic model of the agricultural tractor.

8. The method of claim 7, wherein, in the event of a computational stipulation of the trajectory, the desired position including the spreading extent, the lateral offset, and the height position of the tractor-side coupling points is fixedly set by the control unit.
